(19) United States
(12) Patent Application Publication
(10) Pub. No.: US 2016/0048497 A1
(43) Pub. Date: Feb. 18, 2016

(54) SYSTEM AND METHOD FOR GENERATING AN INTERIOR DESIGN

(71) Applicant: Brinda Goswami, Hyderabad (IN)

(72) Inventor: Brinda Goswami, Hyderabad (IN)

(21) Appl. No.: 14/793,950

(22) Filed: Jul. 8, 2015

(30) Foreign Application Priority Data
Aug. 18, 2014 (IN) 4023/CHE/2014

(51) Int. Cl. G06F 17/27; G06K 9/62; G06F 17/22; G06T 11/20

(52) U.S. Cl. CPC G06F 17/272; G06T 11/20; G06K 9/6201; G06F 17/2247; G06T 2210/04

(57) ABSTRACT

A processor implemented method for generating one or more interior designs for a space using an interior design generation system is provided. The method includes following steps: (i) a user specification is obtained from a user; (ii) the user specification is represented in a markup language to obtain a markup user specification; (iii) the markup user specification is parsed to obtain a markup space characteristic and a markup user characteristic; (iv) the (a) markup space characteristic and (b) markup user characteristic are compared with an interior design that is stored in a database to obtain a list of relevant combination of the relevant interior design components; (vii) the list of relevant combination of the relevant interior design components is arranged based on a set of rules to obtain the interior design representation in the markup language; and (viii) an interior design representation is rendered by a browser on a device.

### CROSS REFERENCE TO RELATED APPLICATIONS

This application claims priority to and the benefit of the provisional patent application number 4023/CHE/2014 titled “System and method for generating an interior design” filed in the Indian Patent Office on Aug. 18, 2014. The specification of the above referenced patent application is incorporated herein by reference in its entirety.

### BACKGROUND

1. Technical Field

The embodiments herein generally relate to an interior design system, and, more particularly, a system and method for automatically generating interior designs.

2. Description of the Related Art

With today's economy and increase in both new and existing home sales, there has been a surge in a desire for homeowners to decorate interiors of their homes. Traditionally, this is achieved by hiring an interior designer who is a consultant for an interior design and decoration of the home. The role of the interior designer is to assist the homeowner deciding the homeowner's design requirements such as color and style. These design requirements are used to select interior design treatments such as fabrics for furniture and window treatments, fabrics, wall coverings such as floor cover and wallpaper, paint colors for floors, walls, trim, and the ceiling. Traditionally, the selection process involves the homeowner and the interior designer meeting personally, reviewing the existing coloring, reviewing the existing furniture, and discussing the “style” or “feel” that the homeowner wishes for the home. The interior designers also bring in a lot of technical expertise in terms of (a) space management, (b) vaastu compliance, (c) requirements of different living areas like what are included in kitchen or living room, (d) electrical requirements given the interior design, (e) plumbing requirements, (f) what material is working in which living area, and (g) estimating the cost of getting the interiors done. The list of technical expertise is very wide and the homeowner terms these as rules and design principles which are used for generating designs.

The interior designers typically charge by the hour rates for this service (e.g., $100 per hour). The time required to decorate an individual room can drive the interior design consulting fee much higher. Therefore, the services of the interior designers are typically limited to only those individuals with sufficient income to afford an interior designer. Accordingly, there remains a need for a cost effective and an efficient way of generating interior design without a human intervention.

### SUMMARY

In view of the foregoing, an embodiment herein provides a processor implemented method for generating at least on interior designs representation for a space using an interior design generation system. The method includes following steps: (i) a user specification that includes at least one space characteristic and at least one user characteristic is obtained from a user; (ii) the user specification is represented in a markup language to obtain a markup user specification; (iii) the markup user specification is parsed to obtain a markup space characteristic and a markup user characteristic; (iv) the (a) markup space characteristic and (b) markup user characteristic are compared with one or more interior design components that is stored in a categorizing database in the markup language to obtain one or more relevant interior design components; (v) the one or more relevant interior design components is compared with one or more combination of the one or more relevant interior design components that is stored in a combination database to obtain a list of combination of the one or more relevant interior design components; (vi) at least one of combination of the one or more relevant interior design components associated with the (a) markup space characteristic and (b) markup user characteristic is recommended to obtain a list of relevant combination of the one or more relevant interior design components; (vii) the list of relevant combination of the one or more relevant interior design components is arranged based on a set of rules to obtain the at least one interior design representation in the markup language; and (viii) at least one interior design representation in the markup language is rendered by a browser on a computing device. In one embodiment, the markup language is at least one of (i) an extensible markup language (XML) format data, or (ii) a javascript object notation (JSON) format data. In one embodiment, the space characteristic is selected from a group including of: (a) a design idea of the space, (b) a type of the space, (c) a design style of the space, and (d) size of the space. In another embodiment, the user characteristic is selected from a group including of: (a) hobbies of the user, (b) color choices of the user for the space, and (c) a budget of the user. In one embodiment, the user specifies what functionality he/she wants in a room (e.g. a reading). The design idea of the space is at least one of: (a) designing a new space, (b) renovating an existing space, and (c) buying furniture for a space. The type of the space is at least one of: (a) a living room, (b) a dinning space, (c) a storage space, (d) kids space, (e) a decor space, and (f) a bedroom. In one embodiment, the size of the space in height*width*length format. The design style of the space is at least one of: (a) an Indian style, (b) a Nordic style, (c) a minimalistic, (d) a modern, (e) a classic, and (f) a bohochic. The hobbies of the user are at least one of: (a) dance, (b) listening to music, (c) reading and writing books, (d) travel, (e) sports, and (f) party. The color choices of the user for the space is at least one of: (a) Barcelona, (b) light the sky, (c) blue humans, (d) hackers, (f) buried at the beach, and (g) attack of mac.

In another aspect, a non-transitory program storage device readable by computer, and includes a program of instructions executable by the computer to perform a method for generating at least one interior design representation for a space is provided. The method includes following steps: (i) a user specification that includes at least one space characteristic and at least one user characteristic is obtained from a user; (ii) the user specification is represented in a markup language to obtain a markup user specification; (iii) the markup user specification is parsed to obtain a markup space characteristic and a markup user characteristic; (iv) the (a) markup space characteristic and (b) markup user characteristic are compared with one or more interior design components that is stored in a categorizing database in the markup language to obtain one or more relevant interior design components; (v) the one or more relevant interior design components is compared with one or more combination of the one or more relevant interior design components that is stored in a combination database to obtain a list of combination of the one or more relevant interior design components; (vi) at least one of combination of the one or more relevant interior design components associated with the (a) markup space characteristic and (b) markup user characteristic is recommended to obtain a list of relevant combination of the one or more relevant interior design components; (vii) the list of relevant combination of the one or more relevant interior design components is arranged based on a set of rules to obtain the at least one interior design representation in the markup language; and (viii) at least one interior design representation in the markup language is rendered by a browser on a computing device. In one embodiment, the markup language is at least one of (i) an extensible markup language (XML) format data, or (ii) a javascript object notation (JSON) format data. In one embodiment, the space characteristic is selected from a group including of: (a) a design idea of the space, (b) a type of the space, (c) a design style of the space, and (d) size of the space. In another embodiment, the user characteristic is selected from a group including of: (a) hobbies of the user, (b) color choices of the user for the space, and (c) a budget of the user. In one embodiment, the user specifies what functionality he/she wants in a room (e.g. a reading). The design idea of the space is at least one of: (a) designing a new space, (b) renovating an existing space, and (c) buying furniture for a space. The type of the space is at least one of: (a) a living room, (b) a dinning space, (c) a storage space, (d) kids space, (e) a decor space, and (f) a bedroom. In one embodiment, the size of the space in height*width*length format. The design style of the space is at least one of: (a) an Indian style, (b) a Nordic style, (c) a minimalistic, (d) a modern, (e) a classic, and (f) a bohochic. The hobbies of the user are at least one of: (a) dance, (b) listening to music, (c) reading and writing books, (d) travel, (e) sports, and (f) party. The color choices of the user for the space is at least one of: (a) Barcelona, (b) light the sky, (c) blue humans, (d) hackers, (f) buried at the beach, and (g) attack of mac.

In yet another aspect, a system for generating at least one interior design representation for a space is provided. The system includes a memory unit, a processor, and a display unit. The memory unit stores a category database, a combination database and a set of modules. The processor executes the set of modules. The set of modules includes a user input obtaining module, a markup language representation module, a parsing module, an interior design category comparison module, an interior design combination comparison module, an interior design components recommending module, and an interior design components arranging module. The user input obtaining module obtains a user specification that includes at least one space characteristic and at least one user characteristic from the user. The markup language representation module represents a markup user specification from the user specification in a markup language. The parsing module parses the markup user specification to obtain (i) a markup space characteristic and (ii) a markup user characteristic. The interior design category comparison module compares the one or more parsed data in the markup language with one or more interior design components that is stored in the categorizing database in the markup language to obtain one or more relevant interior design components. The interior design combination comparison module compares the one or more relevant interior design components with one or more combination of the one or more relevant interior design components that are stored in the combination database to obtain a list of combination of the one or more relevant interior design components. The interior design components recommending module recommends at least one of combination of the one or more relevant interior design components associated with the (i) markup space characteristic and (ii) markup user characteristic to obtain a list of relevant combination of the one or more relevant interior design components. The interior design components arranging module arranges the list of relevant combination of the plurality of relevant interior design components based on a set of rules to obtain the at least one interior design representation in the markup language. In one embodiment, the set of rules is selected from a group including of: (a) color scheme rules, (b) product standard sizes rules, (c) suggestive space related rules, (d) lighting and reflection rules, or (e) any combination thereof. a color scheme rules module that is configured to codify any type of color for different schemes. The different schemes are at least one of: (a) a primary color scheme, (b) a harmonious color Scheme, (c) a natural color scheme, (d) a contrasting color scheme, and (e) a monochromatic color Scheme. The product standard sizes rule module that is configured to maintain standard size while designing the one or more interior design components in the space. The suggestive space related rules module that is configured to ensure enough space flow and ergonomics is maintained in the space. The lighting and reflection rules module that is configured to helps the user to design proper lighting and helps to perform specific tasks, such as reading, grooming, preparing and cooking food, doing homework, working on hobbies, playing games and balancing your checkbook on the space. The display unit displays the at least one interior design representation in the markup language that is rendered by a browser on a computing device. In one embodiment, the markup language is at least one of (i) an extensible markup language (XML) format data, or (ii) a javascript object notation (JSON) format data. In one embodiment, the space characteristic is selected from a group including of: (a) a design idea of the space, (b) a type of the space, (c) a design style of the space, and (d) size of the space. In another embodiment, the user characteristic is selected from a group including of: (a) hobbies of the user, (b) color choices of the user for the space, and (c) a budget of the user. In one embodiment, the user specifies what functionality he/she wants in a room (e.g. a reading). The design idea of the space is at least one of: (a) designing a new space, (b) renovating an existing space, and (c) buying furniture for a space. The type of the space is at least one of: (a) a living room, (b) a dinning space, (c) a storage space, (d) kids space, (e) a decor space, and (f) a bedroom. In one embodiment, the size of the space in height*width*length format. The design style of the space is at least one of: (a) an Indian style, (b) a Nordic style, (c) a minimalistic, (d) a modern, (e) a classic, and (f) a bohochic. The hobbies of the user are at least one of: (a) dance, (b) listening to music, (c) reading and writing books, (d) travel, (e) sports, and (f) party. The color choices of the user for the space is at least one of: (a) Barcelona, (b) light the sky, (c) blue humans, (d) hackers, (f) buried at the beach, and (g) attack of mac.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates a system view of an interior design generation system implemented in a computing device that interacts with a server to generate at least one interior design representation for a space according to an embodiment herein;

FIG. 2 illustrates an exploded view of the interior design generation system of FIG. 1 according to an embodiment herein;

FIG. 3A and FIG. 3B are flow diagrams illustrate a processor implemented method for generating at least one interior design representation for a space according to an embodiment herein;

FIG. 4A illustrates a user interface view of an interior design generation system depicting providing predefined design ideas for a user selection according to an embodiment herein;

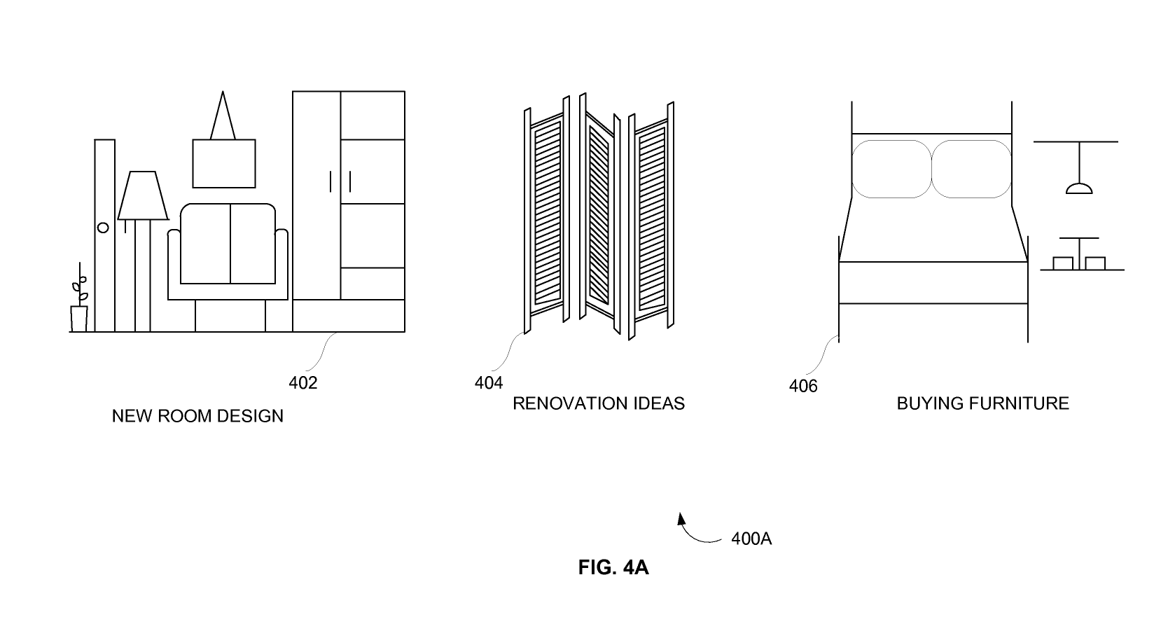

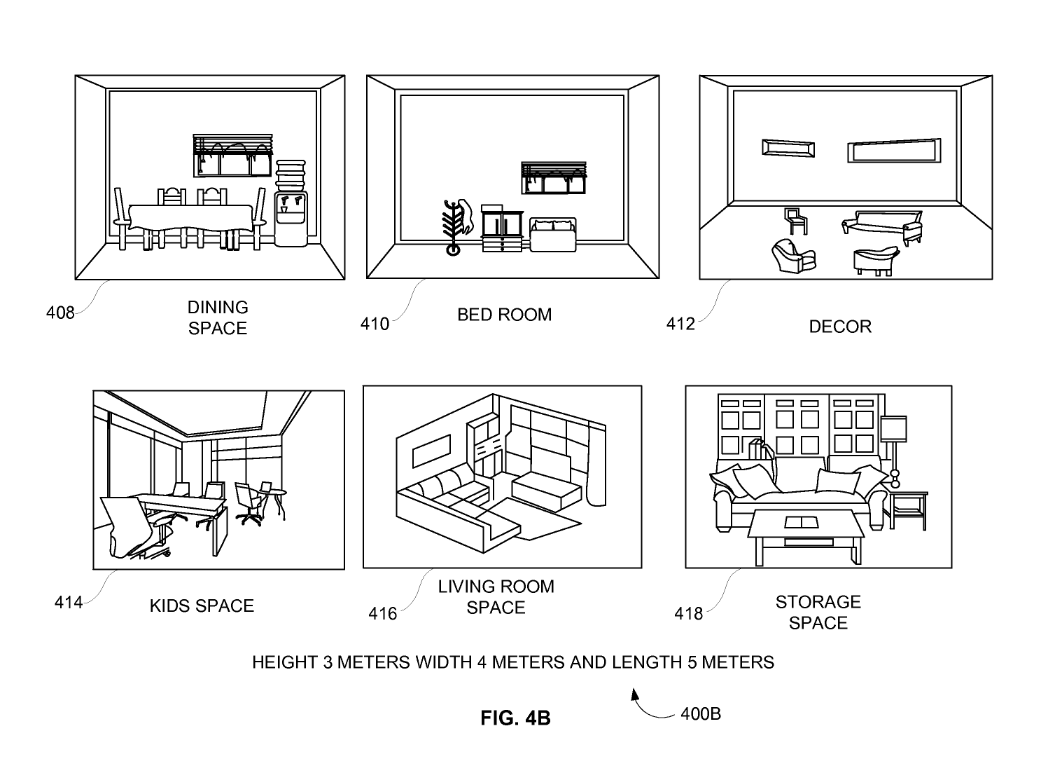

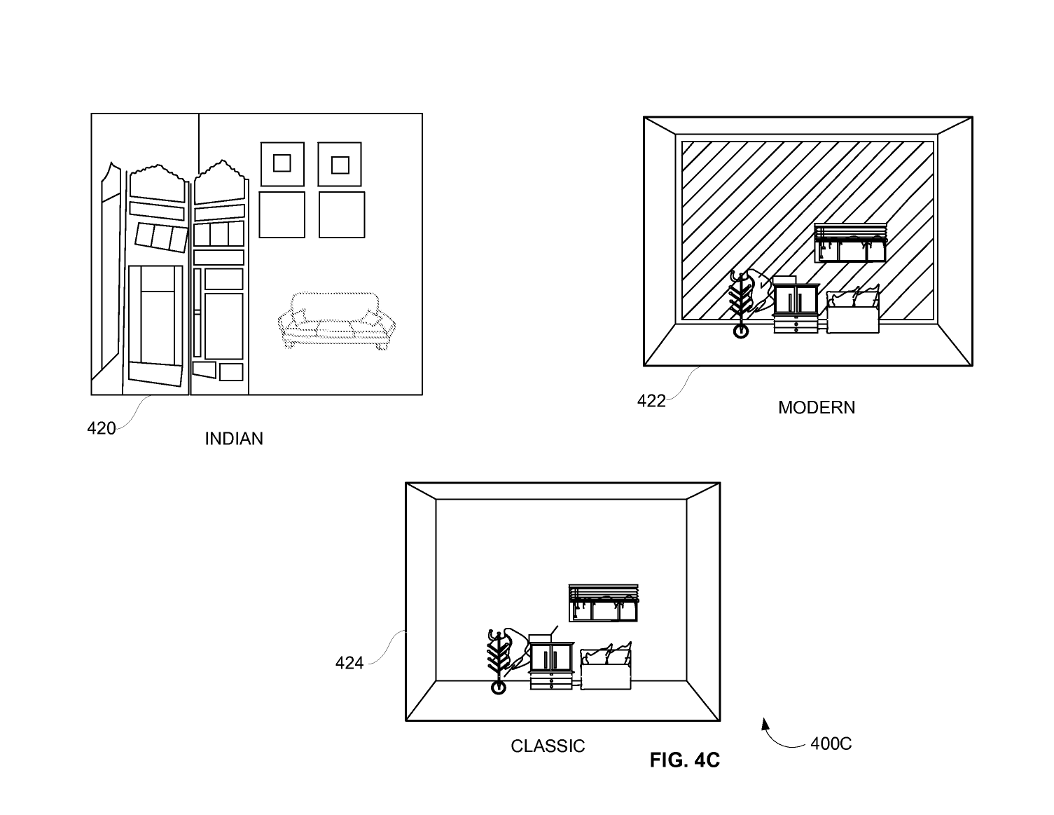

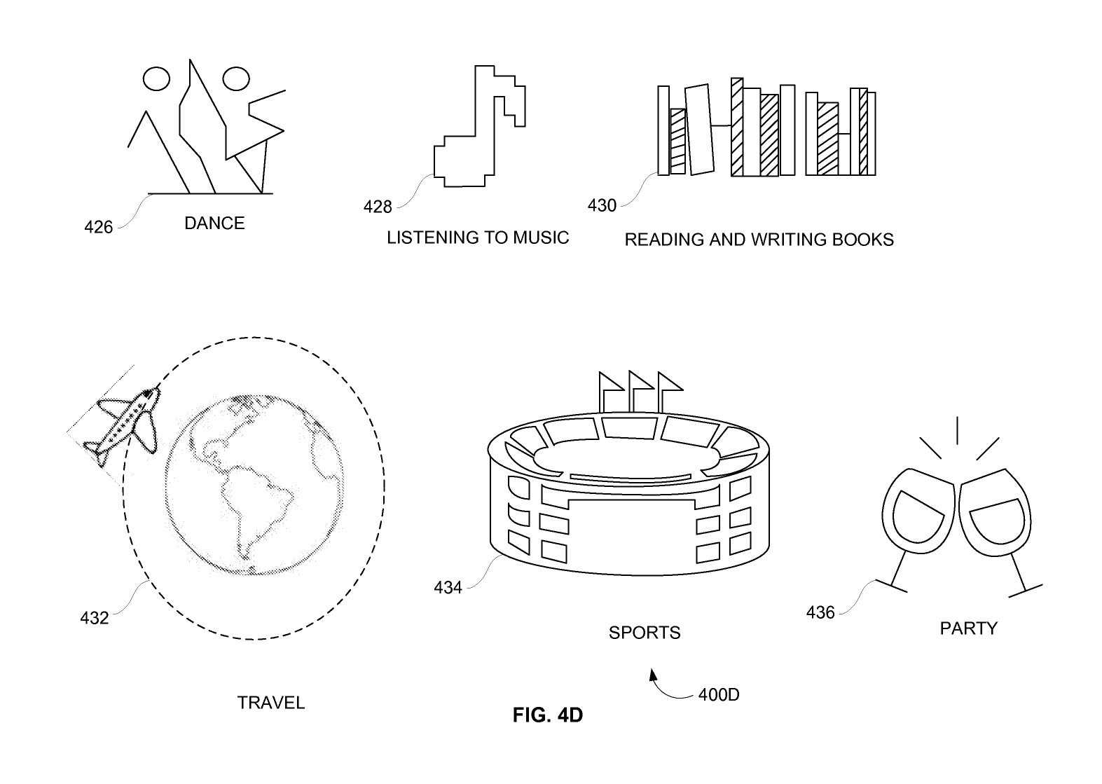

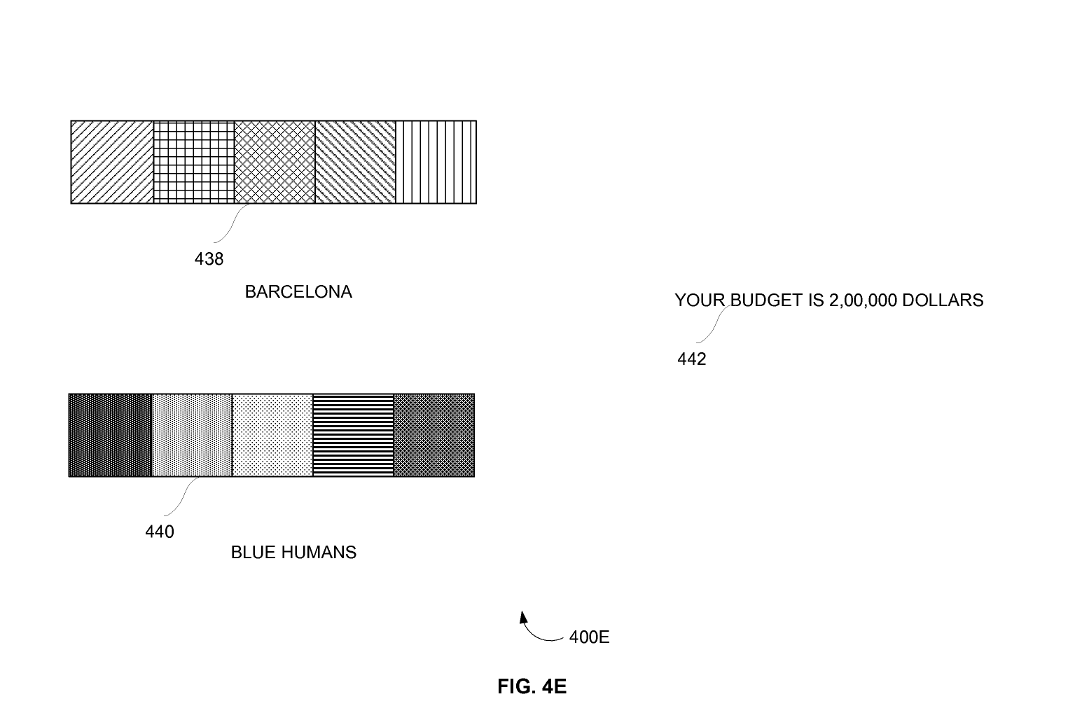

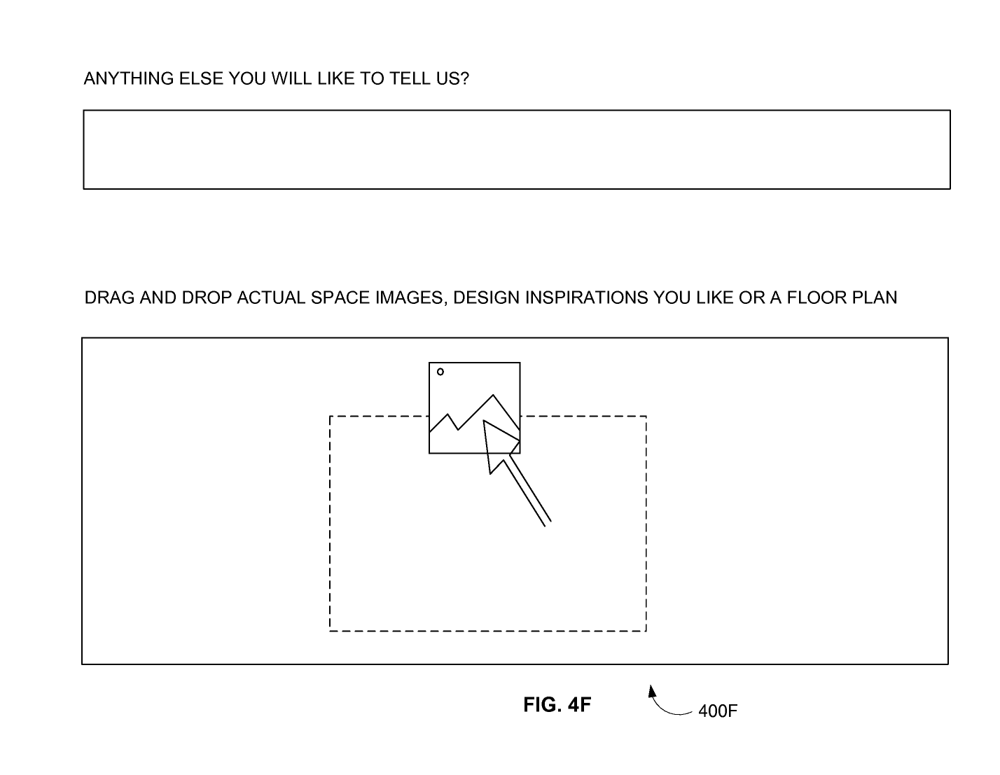

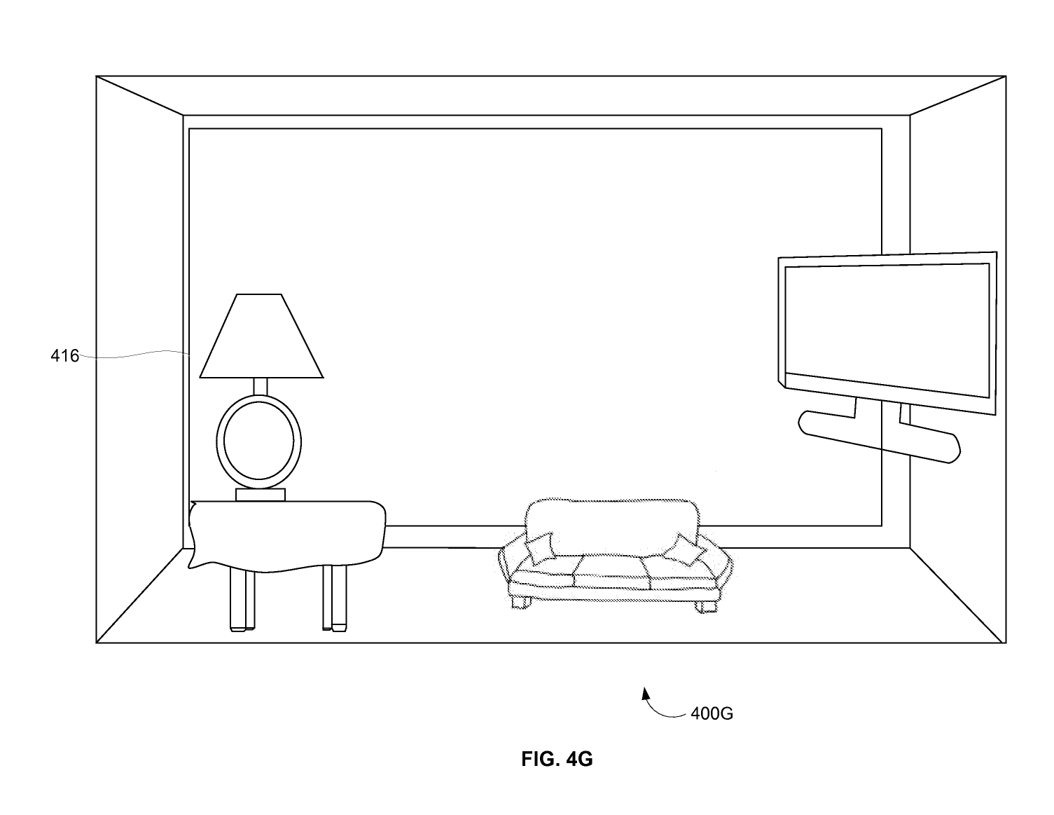

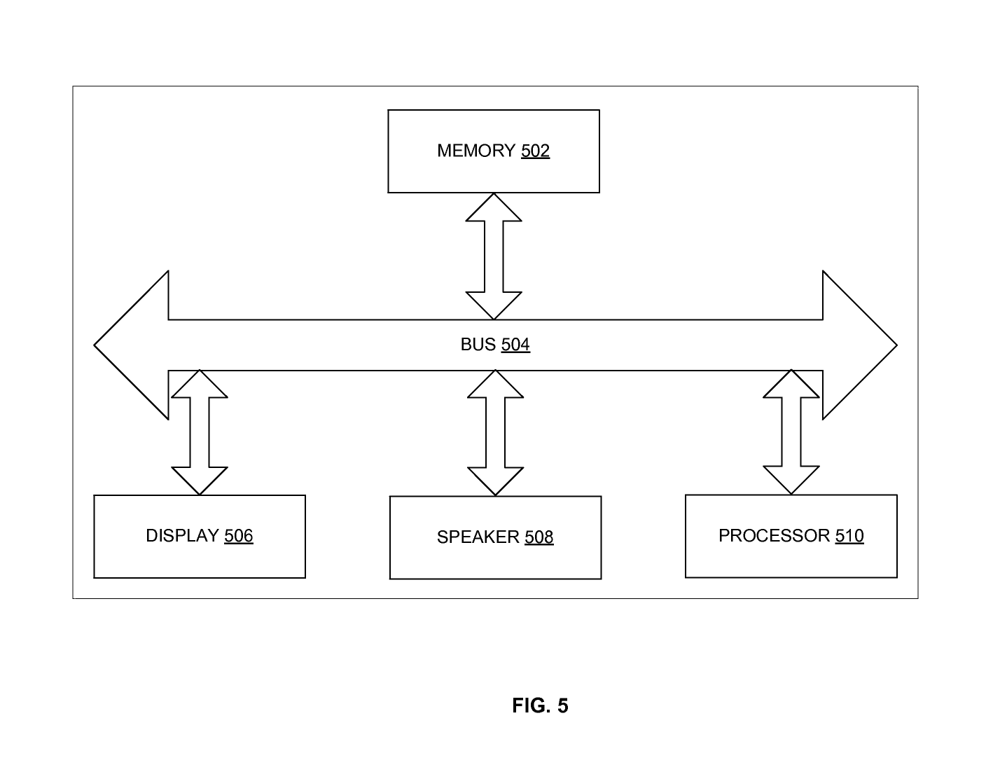

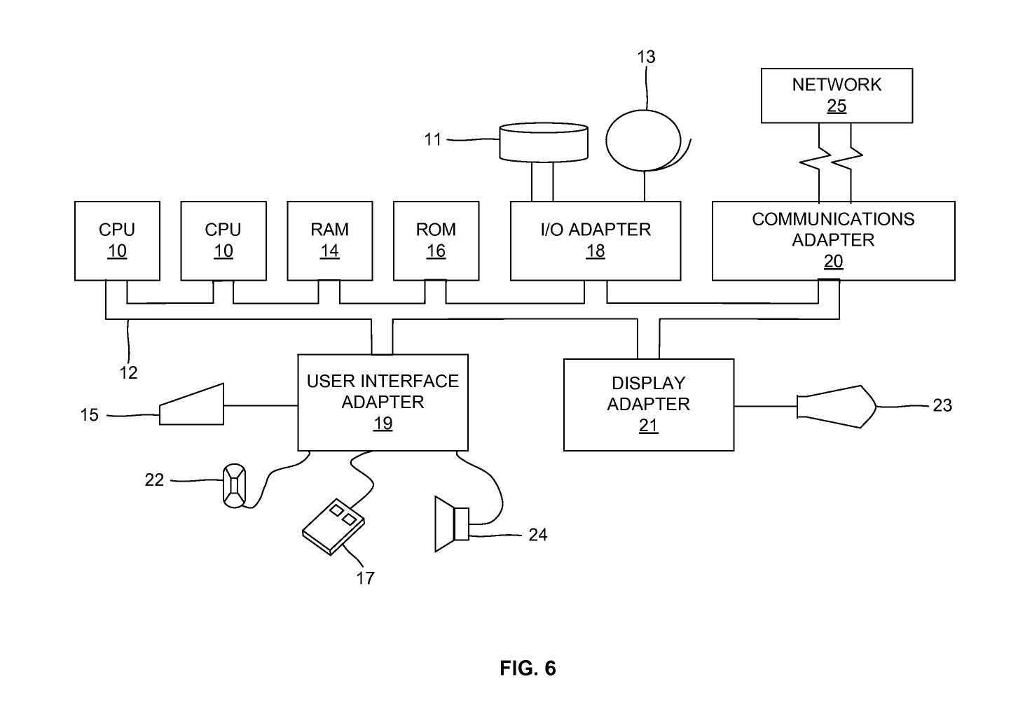

With reference to FIG. 4A, FIG. 4B illustrates a user interface view of an interior design generation system depicting displaying various types of spaces upon the user selects an option of ‘designing a new space’ according to an embodiment herein;

With reference to FIG. 4B, FIG. 4C illustrates a user interface view of an interior design generation system depicting displaying various design styles for the selected space type according to an embodiment herein;

With reference to FIG. 4C, FIG. 4D illustrates a user interface view of an interior design generation system depicting displaying various predefined hobbies for the user selection according to an embodiment herein;

With reference to FIG. 4D, FIG. 4E illustrates a user interface view of an interior design generation system depicting displaying various color choice and a budget for the selected space type according to an embodiment herein;

With reference to FIG. 4E, FIG. 4F illustrates a user interface view of an interior design generation system depicting providing an option to the user to provide actual image of the space according to an embodiment herein;

With reference to FIG. 4F, FIG. 4G illustrates a user interface view of an interior design generation system depicting an interior design representation for a selected space type ‘living room space’ according to an embodiment herein;

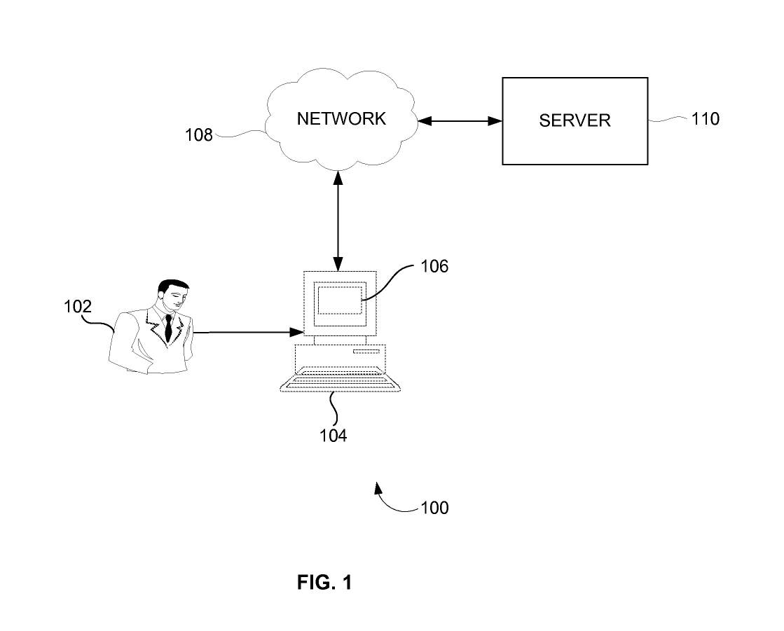

FIG. 5 illustrates an exploded view of the computing device of FIG. 1 according to the embodiments herein; and

FIG. 6 illustrates a schematic diagram of computer architecture used in accordance with the embodiment herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Accordingly, there remains a need for a cost effective and an efficient way of generating interior design without a human intervention. The embodiments herein achieve this by providing an interior design generation system that interacts with a server to generate one or more interior designs based on a design attributes and a set of rules. Referring now to the drawings, and more particularly to FIGS. 1 through 6, where similar reference characters denote corresponding features consistently throughout the figures, there are shown preferred embodiments.

FIG. 1 illustrates a system view 100 of an interior design generation system 106 implemented in a computing device 104 that interacts with a server 110 to generate at least one interior design representation for a space according to an embodiment herein. The system view 100 includes a user 102, the computing device 104, the interior design generation system 106, a network 108, and the server 110. The interior design generation system 106 can be implemented in the computing device 104 that interacts with the server through the network 108 to generate one or more interior designs (e.g., a home interior design) for a space. In one embodiment, the interior design generation system 106 may be implemented in a remote server. In one embodiment, the network 108 may be the internet, or a broadcast network. The interior design generation system 106 obtains one or more user space characteristic and one or more user characteristic as a user specification to generate one or more interior designs (e.g., a home interior design) for a space. In one embodiment, the space characteristic is selected from a group including: (a) a design idea of the space, (b) a type of the space, (c) a design style of the space, and (d) size of the space, the user characteristic is selected from a group including (a) hobbies of a user, (b) color choices of the user for the space, and (c) a budget of the user as a user input information. In one embodiment, a user preference for generating an interior design is obtained from the server 110.

The interior design generation system 106 defines a set of rules and procedures to generate the one or more interior designs. In one embodiment, the one or more interior designs can be generated for one or more rooms in home, and commercial buildings. The user 102 may be a client, and a customer. The computing device 104 may be a personal computer, a laptop, a tablet PC, a smart phone, and a mobile phone.

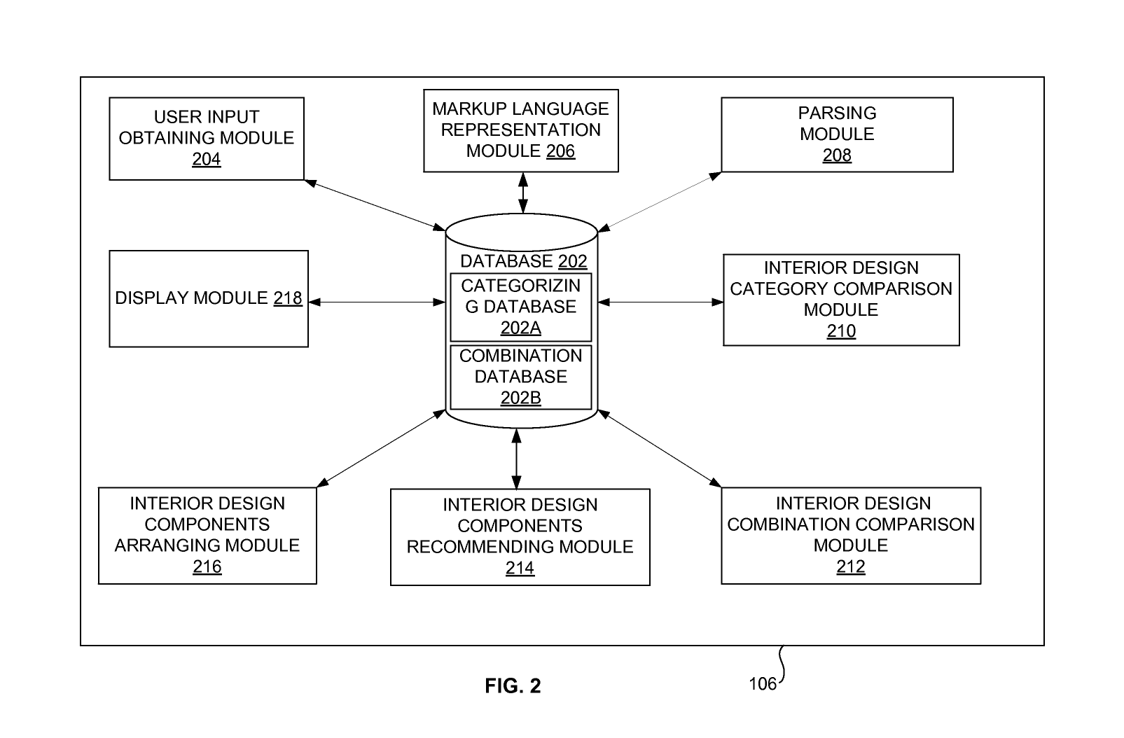

FIG. 2 illustrates an exploded view of the interior design generation system 106 of FIG. 1 according to an embodiment herein. The interior design generation system 106 includes a database 202, a user input obtaining module 204, a markup language representation module 206, a parsing module 208, an interior design category comparison module 210, an interior design combination comparison module 212, an interior design components recommending module 214, an interior design components arranging module 216, and a display module 218. The database 202 includes a categorizing database 202A and a combination database 202B. The user input obtaining module 204 obtains a user specification that includes at least one space characteristic and at least one user characteristic from the user 102. In one embodiment, the space characteristic is selected from a group including of: (a) a design idea of the space, (b) a type of the space, (c) a design style of the space, and (d) size of the space. In another embodiment, the user characteristic is selected from a group including of: (a) hobbies of the user 102, (b) color choices of user 102 for the space, and (c) a budget of the user 102. In another embodiment, the user input obtaining module 204 provides an option to the user 102 to provide an option to change the user specification of one or more interior designs to generate one or more new interior designs. In one embodiment, when a user comes and specifies his/her preferences, chances are that a right design image that he/she is looking for is already created by a batch process.

The batch is an executable/service which takes specific inputs and produces a standard output. For example, a designer designs a room which is in a form of a data template and saves a designed room. The batch process picks up the design, and replaces all the components with similar dimensions and auto-saves the new templates after addition of base image of new components, hence, automatically creating multiple design template by adding various combinations of the components to the template saved by the designer.

The markup language representation module 206 represents a markup user specification from the user specification in a markup language. In one embodiment, the markup language is (i) an Extensible Markup Language (XML) format data and/or (ii) a JavaScript Object Notation (JSON) format data. Example for XML format data:

```
<chair>
      <type>Wooden</type>
      <model>Classic</model>
      <No. of chairs>four</No. of chairs>
</chair>
```

The parsing module 208 parses the markup user specification to obtain (i) a markup space characteristic and (ii) a markup user characteristic. The interior design category comparison module 210 compares the one or more parsed data in the markup language with one or more interior design components that is stored in the categorizing database 202A in the markup language to obtain one or more relevant interior design components. The interior design combination comparison module 212 compares the one or more relevant interior design components with one or more combination of the one or more relevant interior design components that is stored in the combination database 202B to obtain a list of combinations of the one or more relevant interior design components. The interior design components recommending module 214 recommends at least one of combination of the one or more relevant interior design components associated with the (i) markup space characteristic and (ii) markup user characteristic to obtain a list of relevant combination of the one or more relevant interior design components. The interior design components arranging module 216 arranges the list of relevant combination of the plurality of relevant interior design components based on a set of rules to obtain the at least one interior design representation in the markup language. The display module 218 renders the at least one interior design representation in the markup language by a browser on a device. In one embodiment, the set of rules is selected from a group including of: (a) color scheme rules, (b) product standard sizes rules, (c) suggestive space related rules, (d) lighting and reflection rules, or (e) any combination thereof. The set of rules and the design principles are obtained. For example, the set of rules pertain to color combinations that look “good”, space analysis, orientations, “styles” of furniture and styles of designs that match with each other. In one embodiment, the interior design components arranging module 216 analyzes the set of rules and the design principles which when applied on the relevant components (e.g., a sofa, walls) are combined to create complete room designs. The color schemes rules may be maintained by codifying any type of color rule for different schemes (e.g., a primary color scheme, a harmonious color scheme, a natural color scheme, a contrasting color scheme, a monochromatic color scheme). For example, a rule that can be easily codified using a monochromatic color scheme is as follows (i) if all the walls are grey, furniture can be in black, and (ii) colors that go well together should be related to the family of colors.

Similarly, the product standard sizes rules which are standard guidelines that need to be maintained while designing the physical components in a room. The variations may be based on functions performed in the room. For example, a wardrobe standard height is seven feet+loft two feet, a double bed size is minimum of 5 by 6.

Similarly, the suggestive space related rules can be used to ensure enough space flow and ergonomics is maintained in the design. For example, a passage can be minimum two and a half feet wide. The material which is placed in a middle of the room should have a peripheral area of around three feet. The one or more designs are compared with the inputted user requirements to generate a customized interior design and shared with the client on the computing device 104.

Similarly, the lighting and reflection rules can be helps the user 102 to live better in enclosed spaces and helps to perform specific tasks, such as reading, grooming, preparing and cooking food, doing homework, working on hobbies, playing games and balancing your checkbook. For example, (i) every room should have four lights, (ii) wherever a painting or an artefact placed, the painting or the artefact should have a spotlight on top of it, (iii) mirror should not be in front of the bed.

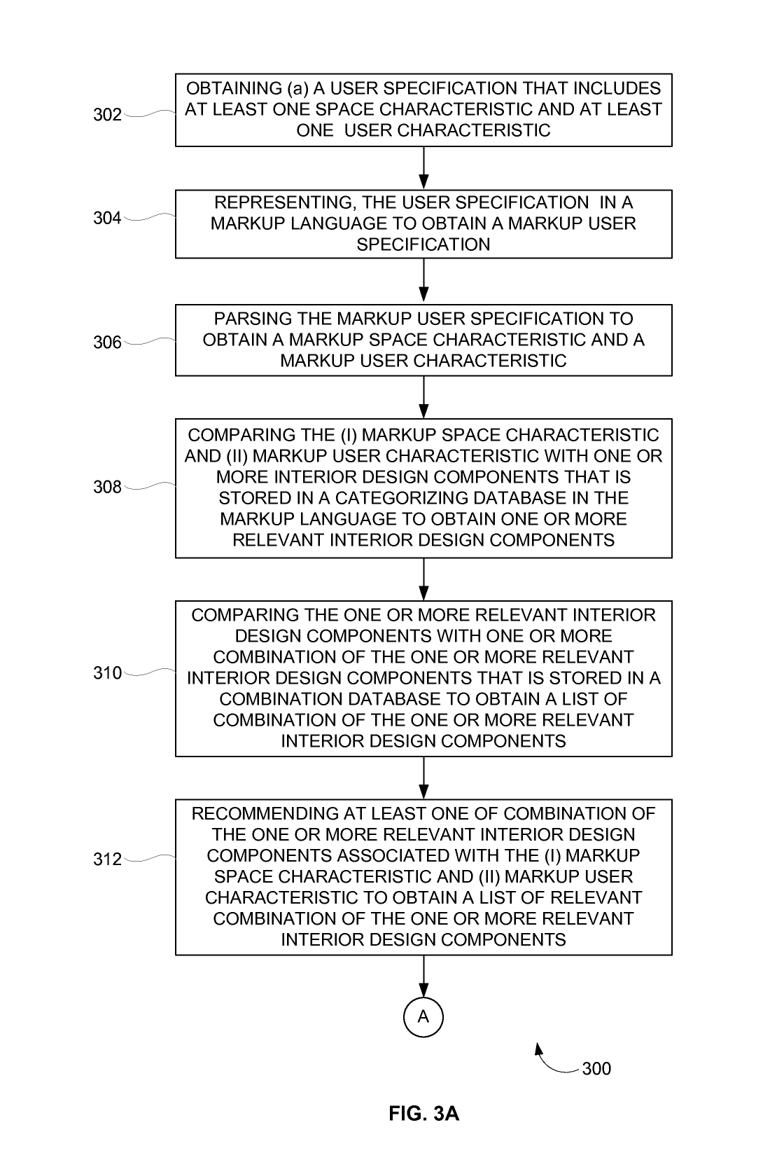

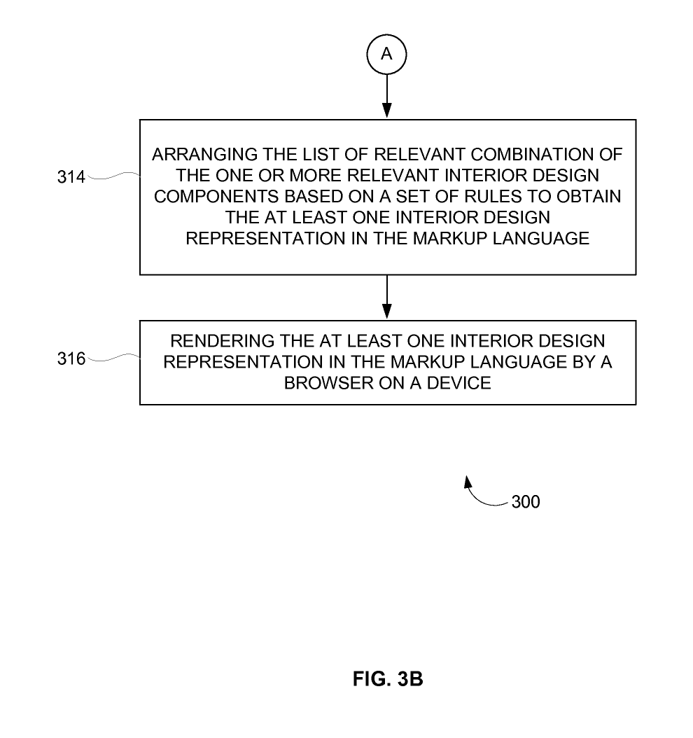

FIG. 3A and FIG. 3B are flow diagrams 300 illustrate a processor implemented method for generating at least one interior design representation for a space according to an embodiment herein. In step 302, a user specification that includes at least one space characteristic and at least one user characteristic is obtained from a user 102. In one embodiment, the space characteristic is selected from a group including of: (a) a design idea of the space, (b) a type of the space, (c) a design style of the space, and (d) size of the space. In another embodiment, the user characteristic is selected from a group including of: (a) hobbies of the user 102, (b) color choices of the user for the space, and (c) a budget of the user 102. In one embodiment, the user specifies what functionality he/she wants in a room (e.g. a reading). The design idea of the space is at least one of: (a) designing a new space, (b) renovating an existing space, and (c) buying furniture for a space. The type of the space is at least one of: (a) a living room, (b) a dinning space, (c) a storage space, (d) kids space, (e) a decor space, and (f) a bedroom. In one embodiment, the size of the space in height*width*length format. The design style of the space is at least one of: (a) an Indian style, (b) a Nordic style, (c) a minimalistic, (d) a modern, (e) a classic, and (f) a bohochic. The hobbies of the user 102 are at least one of: (a) dance, (b) listening to music, (c) reading and writing books, (d) travel, (e) sports, and (f) party. The color choices of the user 102 for the space is at least one of: (a) Barcelona, (b) light the sky, (c) blue humans, (d) hackers, (f) buried at the beach, and (g) attack of mac. In step 304, the user specification is represented in a markup language to obtain a markup user specification. In one embodiment, the markup language is at least one of (i) an extensible markup language (XML) format data, or (ii) a javascript object notation (JSON) format data. In step 306, the markup user specification is parsed to obtain a markup space characteristic and a markup user characteristic. In step 308, the (i) markup space characteristic and (ii) markup user characteristic are compared with one or more interior design components that is stored in a categorizing database in the markup language to obtain one or more relevant interior design components. In step 310, the one or more relevant interior design components is compared with one or more combination of the one or more relevant interior design components that is stored in a combination database to obtain a list of combination of the one or more relevant interior design components. In step 312, at least one of combination of the one or more relevant interior design components associated with the (i) markup space characteristic and (ii) markup user characteristic is recommended to obtain a list of relevant combination of the one or more relevant interior design components. In step 314, the list of relevant combination of the one or more relevant interior design components is arranged based on a set of rules to obtain the at least one interior design representation in the markup language. In one embodiment, set of rules is selected from a group including of: (a) color scheme rules, (b) product standard sizes rules, (c) suggestive space related rules, and (d) lighting and reflection rules. In step 316, at least one interior design representation in the markup language is rendered by a browser on the computing device 104.

FIG. 4A illustrates a user interface view 400A of an interior design generation system 106 depicting providing predefined design ideas for a user selection according to an embodiment herein. In one embodiment, the predefined design ideas for a space includes at least one of, but not limited to, (a) designing a new space 402, (b) renovating an existing space 404, and (c) buying furniture for a space 406. For example, when the user 102 intents to design his/her new space, he/she selects a predefined design idea ‘designing a new space 402’. In another example, if the user 102 intents to renovate his/her existing space, he/she selects a predefined design idea ‘renovating an existing space 404’. Similarly, the user 102 selects an option of ‘buying furniture for a space 406’ when the user 102 is interested in purchasing furniture for a space.

With reference to FIG. 4A, FIG. 4B illustrates a user interface view 400B of an interior design generation system 106 depicting displaying various types of space 408-418 upon the user 102 selects an option of ‘designing a new space 402’ according to an embodiment herein. In one embodiment, the types of spaces that are displayed are, but not limited to, (a) a dinning space 408, (b) a bedroom 410, (c) a décor 412, (d) kids space 414, (e) a living room space 416, and/or (f) a storage space 418. The user 102 selects a space type from the types of spaces being displayed for generating a design. In one embodiment, the user 102 provides an input including a desired area of a selected space type. For example, the user 102 selects a living room space 416, and provides a desired area of the living room space 416 as height 3 meters, width 4 meters, and length 5 meters.

With reference to FIG. 4B, FIG. 4C illustrates a user interface view 400C of an interior design generation system 106 depicting displaying various design 420-424 styles for the selected space type according to an embodiment herein. In one embodiment, design styles for the space is, but not limited to, (a) an Indian style 420, (b) a Nordic style (not shown in FIG. 4C), (c) a minimalistic (not shown in FIG. 4C), (d) a modern 422, (e) a classic 424, and (f) a bohochic (not shown in FIG. 4C). The user 102 selects a desired style from the design styles for applying to the selected space type. For example, the user 102 selects a modern style for applying to the selected space type ‘living room space 416’.

With reference to FIG. 4C, FIG. 4D illustrates a user interface view 400D of an interior design generation system 106 depicting displaying various predefined hobbies 426-436 for the user 102 selection according to an embodiment herein. In one embodiment, the hobbies of the user 102 is, but not limited to, (a) dance 426, (b) listening to music 428, (c) reading and writing books 430, (d) travel 432, (e) sports 434, and (f) party 436. The user 102 selects one or more hobbies from the predefined hobbies 426-436 for applying to the selected space type. For example, the user 102 selects ‘listening to music 428’ as his/her hobby for adding a music system to the selected space type ‘living room space 416’.

With reference to FIG. 4D, FIG. 4E illustrates a user interface view 400E of an interior design generation system 106 depicting displaying various color choice and a budget for the selected space type according to an embodiment herein. In one embodiment, the color choices of the user 102 for the selected space type is, but not limited to: (a) Barcelona 438, (b) light the sky (not shown in FIG. 4E), (c) blue humans 440, (d) hackers (not shown in FIG. 4E), (f) buried at the beach (not shown in FIG. 4E), and/or (g) attack of mac (not shown in FIG. 4E). In another embodiment, the budget 442 of the user 102 for the selected space type is in dollars. For example, the user 102 selects the color choice ‘Barcelona 438’ for applying to the selected space type ‘living room space 416’. In another example, the user's 102 budget 442 is 200,000 dollars for the selected space type ‘living room space 416’.

With reference to FIG. 4E, FIG. 4F illustrates a user interface view 400F of an interior design generation system 106 depicting providing an option to the user 102 to provide actual image of the space according to an embodiment herein. In one embodiment, the user 102 provides actual images of the space, design inspiration for the space. For example, the user 102 provide an actual image of the space, the interior design generation system 106 process the actual image and generates design for the selected space type ‘living room space 416’ based on the actual image of the space. In another example, the user 102 provides a floor plan for designing floor of the selected space type ‘living room space 416’.

FIG. 4G illustrates a user interface view 400G of an interior design generation system 106 depicting an interior design representation for the selected room type ‘living room 416’ according to an embodiment herein. The user interface view 400G displays the interior design representation for the selected space type ‘living room space 416’ base on the user 102 specification.

FIG. 5 illustrates an exploded view of the computing device 104 having an a memory 502 having a set of computer instructions, a bus 504, a display 506, a speaker 508, and a processor 510 capable of processing a set of instructions to perform any one or more of the methodologies herein, according to an embodiment herein. In one embodiment, the receiver may be the computing device 104. The processor 510 may also enable digital content to be consumed in the form of video for output via one or more displays 506 or audio for output via speaker and/or earphones 508. The processor 510 may also carry out the methods described herein and in accordance with the embodiments herein.

Digital content may also be stored in the memory 502 for future processing or consumption. The memory 502 may also store program specific information and/or service information (PSI/SI), including information about digital content (e.g., the detected information bits) available in the future or stored from the past. A user of the personal communication device may view this stored information on display 506 and select an item of for viewing, listening, or other uses via input, which may take the form of keypad, scroll, or other input device(s) or combinations thereof. When digital content is selected, the processor 510 may pass information. The content and PSI/SI may be passed among functions within the personal communication device using the bus 504.

The techniques provided by the embodiments herein may be implemented on an integrated circuit chip (not shown). The chip design is created in a graphical computer programming language, and stored in a computer storage medium (such as a disk, tape, physical hard drive, or virtual hard drive such as in a storage access network). If the designer does not fabricate chips or the photolithographic masks used to fabricate chips, the designer transmits the resulting design by physical means (e.g., by providing a copy of the storage medium storing the design) or electronically (e.g., through the Internet) to such entities, directly or indirectly.

The stored design is then converted into the appropriate format (e.g., GDSII) for the fabrication of photolithographic masks, which typically include multiple copies of the chip design in question that are to be formed on a wafer. The photolithographic masks are utilized to define areas of the wafer (and/or the layers thereon) to be etched or otherwise processed.

The resulting integrated circuit chips can be distributed by the fabricator in raw wafer form (that is, as a single wafer that has multiple unpackaged chips), as a bare die, or in a packaged form. In the latter case the chip is mounted in a single chip package (such as a plastic carrier, with leads that are affixed to a motherboard or other higher level carrier) or in a multichip package (such as a ceramic carrier that has either or both surface interconnections or buried interconnections). In any case the chip is then integrated with other chips, discrete circuit elements, and/or other signal processing devices as part of either (a) an intermediate product, such as a motherboard, or (b) an end product. The end product can be any product that includes integrated circuit chips, ranging from toys and other low-end applications to advanced computer products having a display, a keyboard or other input device, and a central processor.

The embodiments herein can take the form of, an entirely hardware embodiment, an entirely software embodiment or an embodiment including both hardware and software elements. The embodiments that are implemented in software include but are not limited to, firmware, resident software, microcode, etc. Furthermore, the embodiments herein can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, remote controls, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments herein is depicted in FIG. 6. This schematic drawing illustrates a hardware configuration of an information handling/computer system in accordance with the embodiments herein. The system comprises at least one processor or central processing unit (CPU) 10. The CPUs 10 are interconnected via system bus 12 to various devices such as a random access memory (RAM) 14, read-only memory (ROM) 16, and an input/output (I/O) adapter 18. The I/O adapter 18 can connect to peripheral devices, such as disk units 11 and tape drives 13, or other program storage devices that are readable by the system. The system can read the inventive instructions on the program storage devices and follow these instructions to execute the methodology of the embodiments herein.

The system further includes a user interface adapter 19 that connects a keyboard 15, mouse 17, speaker 24, microphone 22, and/or other user interface devices such as a touch screen device (not shown) or a remote control to the bus 12 to gather user input. Additionally, a communication adapter 20 connects the bus 12 to a data processing network 25, and a display adapter 21 connects the bus 12 to a display device 23 which may be embodied as an output device such as a monitor, printer, or transmitter, for example.

The interior design generation application 106 helps to generate the algorithmic based interior design. The implementation which have low cost in terms of computation, quick way to achieve interior design, and easy to create visualization. The rules are of utmost importance to an interior designing as it helps maintain balance in design and ergonomics of the room. The interior design generation application 106 has an extensible framework incorporated for embedding any kind of rules in future. The interior design generation application 106 which have an ability to identify any layout or room furniture arrangement uniquely. The interior design generation application 106 which can convert any design (represented by colors or wall papers) in form of identifiable and searchable DATA.

The interior design generation system 106 helps in ability to generate or suggest designs proactively irrespective of the user input. The interior design generation system 106 contains similar rule set or intelligence that an interior designer uses to generate designs. The interior design generation system 106 includes the ability to generate designs, but also tell which products are used to combine the design, (e.g., how much the room is going to cost and who is vendor in your area of vicinity). The interior design generation system 106 performs various “design checks” to make sure that the design is valid and looks good from multiple perspectives. For example, by performing a space flow analysis to make sure there is enough space for movement. Similarly, a colour soul consistency check is performed to ensure that overall colour scheme is maintained.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A processor implemented method for generating at least one interior design representation for a space, said method comprising:
obtaining a user specification that comprises at least one space characteristic and at least one user characteristic;
representing said user specification in a markup language to obtain a markup user specification;
parsing said markup user specification to obtain a markup space characteristic and a markup user characteristic;
comparing said (i) markup space characteristic and (ii) markup user characteristic with a plurality of interior design components that is stored in a categorizing database in said markup language to obtain a plurality of relevant interior design components;
comparing said plurality of relevant interior design components with a plurality of combination of said plurality of relevant interior design components that is stored in a combination database to obtain a list of combination of said plurality of relevant interior design components;
recommending at least one of combination of said plurality of relevant interior design components associated with said (i) markup space characteristic and (ii) markup user characteristic to obtain a list of relevant combination of said plurality of relevant interior design components; arranging said list of relevant combination of said plurality of relevant interior design components based on a set of rules to obtain said at least one interior design representation in said markup language, wherein said set of rules is selected from a group comprising of: (a) color scheme rules, (b) product standard sizes rules, (c) suggestive space related rules, and (d) lighting and reflection rules, wherein said at least one interior design representation in said markup language is configured to rendered by a browser on a device.

2. The processor implemented method of claim 1, wherein said markup language is at least one of (i) an extensible markup language (XML) format data, or (ii) a javascript object notation (JSON) format data.

3. The processor implemented method of claim 1, wherein said space characteristic is selected from a group comprises of: (a) a design idea of said space, (b) a type of said space, (c) a design style of said space, and (d) size of said space, wherein said user characteristic is selected from a group comprises of: (a) hobbies of a user, (b) color choices of said user for said space, and (c) a budget of said user.

4. The processor implemented method of claim 3, wherein said design idea of said space is at least one of: (a) designing a new space, (b) renovating an existing space, and (c) buying furniture for a space.

5. The processor implemented method of claim 3, wherein said type of said space is at least one of: (a) a living room, (b) a dinning space, (c) a storage space, (d) kids space, (e) a decor space, and (f) a bedroom, wherein said size of said space in height*width*length format.

6. The processor implemented method of claim 3, wherein said design style of said space is at least one of: (a) an Indian style, (b) a Nordic style, (c) a minimalistic, (d) a modern, (e) a classic, and (f) a bohochic.

7. The processor implemented method of claim 3, wherein said hobbies of said user is at least one of: (a) dance, (b) listening to music, (c) reading and writing books, (d) travel, (e) sports, and (f) party, wherein said color choices of said user for said space is at least one of: (a) Barcelona, (b) light the sky, (c) blue humans, (d) hackers, (f) buried at the beach, and (g) attack of mac.

8. A non-transitory program storage device readable by computer, and comprising a program of instructions executable by said computer to perform a processor implemented method for generating at least one interior design representation for a space, said method comprising;
obtaining a user specification that comprises at least one space characteristic and at least one user characteristic;
representing said user specification in a markup language to obtain a markup user specification;
parsing said markup user specification to obtain a markup space characteristic and a markup user characteristic;
comparing said (i) markup space characteristic and (ii) markup user characteristic with a plurality of interior design components that is stored in a categorizing database in said markup language to obtain a plurality of relevant interior design components;
comparing said plurality of relevant interior design components with a plurality of combination of said plurality of relevant interior design components that is stored in a combination database to obtain a list of combination of said plurality of relevant interior design components;
recommending at least one of combination of said plurality of relevant interior design components associated with said (i) markup space characteristic and (ii) markup user characteristic to obtain a list of relevant combination of said plurality of relevant interior design components;
arranging said list of relevant combination of said plurality of relevant interior design components based on a set of rules to obtain said at least one interior design representation in said markup language, wherein said set of rules is selected from a group comprising of: (a) color scheme rules, (b) product standard sizes rules, (c) suggestive space related rules, and (d) lighting and reflection rules, wherein said at least one interior design representation in said markup language is configured to rendered by a browser on a device.

9. The non-transitory machine-readable medium of claim 8 wherein said markup language is at least one of (i) an extensible markup language (XML) format data, or (ii) a javascript object notation (JSON) format data.

10. The non-transitory machine-readable medium of claim 8, wherein said space characteristic is selected from a group comprises of: (a) a design idea of said space, (b) a type of said space, (c) a design style of said space, and (d) size of said space, wherein said user characteristic is selected from a group comprises of: (a) hobbies of a user, (b) color choices of said user for said space, and (c) a budget of said user.

11. The non-transitory machine-readable medium of claim 10, wherein said design idea of said space is at least one of: (a) designing a new space, (b) renovating an existing space, and (c) buying furniture for a space.

12. The non-transitory machine-readable medium of claim 10, wherein said type of said space is at least one of: (a) a living room, (b) a dinning space, (c) a storage space, (d) kids space, (e) a decor space, and (f) a bedroom, wherein said size of said space in height*width*length format.

13. The non-transitory machine-readable medium of claim 10, wherein said design style of said space is at least one of: (a) an Indian style, (b) a Nordic style, (c) a minimalistic, (d) a modern, (e) a classic, and (f) a bohochic.

14. The non-transitory machine-readable medium of claim 10, wherein said hobbies of said user is at least one of: (a) dance, (b) listening to music, (c) reading and writing books, (d) travel, (e) sports, and (f) party, wherein said color choices of said user for said space is at least one of: (a) Barcelona, (b) light the sky, (c) blue humans, (d) hackers, (f) buried at the beach, and (g) attack of mac.

15. A system for generating at least one interior design representation for a space, comprising:
a memory unit that stores a categorizing database, a combination and a set of modules;
a processor that executes said set of modules, wherein said set of modules comprises:
a user input obtaining module, executed by said processor, configured to obtain a user specification that comprises at least one space characteristic and at least one user characteristic;
a markup language representation module, executed by said processor, configured to represent a markup user specification from said user specification in a markup language;
a parsing module configured to parse said markup user specification to obtain a markup space characteristic and a markup user characteristic;
an interior design category comparison module, executed by said processor, configured to compare said (i) markup space characteristic and (ii) markup user characteristic with a plurality of interior design components that is stored in a categorizing database in said markup language to obtain a plurality of relevant interior design components;
an interior design combination comparison module, executed by said processor, configured to compare said plurality of relevant interior design components with a plurality of combination of said plurality of relevant interior design components that is stored in a combination database to obtain a list of combination of said plurality of relevant interior design components;
an interior design components recommending module, executed by said processor, configured to recommend at least one of combination of said plurality of relevant interior design components associated with said (i) markup space characteristic and (ii) markup user characteristic to obtain a list of relevant combination of said plurality of relevant interior design components;
an interior design components arranging module, executed by said processor, configured to arrange said list of relevant combination of said plurality of relevant interior design components based on a set of rules to obtain said at least one interior design representation in said markup language, wherein said set of rules is selected from a group comprising of:
a color scheme rules module that is configured to codify any type of color for different schemes, wherein said different schemes are at least one of: (a) a primary color scheme, (b) a harmonious color Scheme, (c) a natural color scheme, (d) a contrasting color scheme, and (e) a monochromatic Color Scheme;
a product standard sizes rules module that is configured to maintain standard size while designing said plurality of interior design components in said space;
a suggestive space related rules module that is configured to ensure enough space flow and ergonomics is maintained in said space;
a lighting and reflection rules module that is configured to helps said to user to design proper lighting and helps to perform specific tasks, such as reading, grooming, preparing and cooking food, doing homework, working on hobbies, playing games and balancing your checkbook on said space;
a display unit configured to display said at least one interior design representation in said markup language that is rendered by a browser on a device.

16. The system of claim 15, wherein said space characteristic is selected from a group of comprises: (a) a design idea of said space, (b) a type of said space, (c) a design style of said space, and (d) size of said space, wherein said user characteristic is selected from a group of comprises (a) hobbies of a user, (b) color choices of said user for said space, and (c) a budget of said user.

17. The system of claim 16, wherein said design idea of said space is at least one of: (a) designing a new space, (b) renovating an existing space, and (c) buying furniture for a space.

18. The system of claim 16, wherein said type of said space is at least one of: (a) a living room, (b) a dinning space, (c) a storage space, (d) kids space, (e) a decor space, and (f) a bedroom, wherein said size of said space in height*width*length format.

19. The system of claim 16, wherein said design style of said space is at least one of: (a) an Indian style, (b) a Nordic style, (c) a minimalistic, (d) a modern, (e) a classic, and (f) a bohochic.

20. The system of claim 16, wherein said hobbies of said user is at least one of: (a) dance, (b) listening to music, (c) reading and writing books, (d) travel, (e) sports, and (f) party, wherein said color choices of said user for said space is at least one of: (a) Barcelona, (b) light the sky, (c) blue humans, (d) hackers, (f) buried at the beach, and (g) attack of mac.
